(19) United States
(12) Patent Application Publication
(10) Pub. No.: US 2024/0249852 A1
(43) Pub. Date: Jul. 25, 2024

(54) FISSION PRODUCT TRAP FOR SALT PIPE AND PUMP SHAFT SEALS AND METHODS OF USE THEREOF

(71) Applicants: ABILENE CHRISTIAN UNIVERSITY, Abilene, TX (US); Board of Regents, The University of Texas System, Austin, TX (US)

(72) Inventors: Timothy Head, Abilene, TX (US); Derek Haas, Austin, TX (US)

(21) Appl. No.: 18/157,561

(22) Filed: Jan. 20, 2023

(51) Int. Cl. G21C 19/50; G21C 3/54; G21C 19/48

(52) U.S. Cl. CPC G21C 19/50; G21C 3/54; G21C 19/48

(57) ABSTRACT

A fission product trap for a reactor system, such as for a pipe connection and/or a pump shaft of a pump of the reactor system, includes a porous container. The porous container may be mounted about the pipe connection and/or pump shaft and include an absorbing material contained therein. The absorbing material may be configured to collect fission products emitted from the pipe connection and/or the pump shaft. The fission product trap further includes an assembly encompassing the porous container and that defines a volume about the porous container and the pipe connection and/or the pump shaft.

### TECHNICAL FIELD

The described examples relate generally to systems, devices, and techniques for mitigating the environmental, health, and safety impacts associated with the emission of fission products in a reactor system, such as a molten salt reactor system.

### BACKGROUND

Fission products may be emitted from certain components within a reactor system, such a molten salt reactor system. As one example, radioactive iodine or other fission products may be emitted from a connection or junction of two pipes of the reactor system. As another example, radioactive iodine or other fission products may be emitted from or along a pump shaft of a pump of the reactor system. Emission of such fission products may cause certain undesirable environmental, health, and safety conditions within the reactor system. While the reactor system may be housed or otherwise contained within an enclosure or containment vessel, it may be desirable to limit the buildup of fission products within such containment. As such, there is a need for systems and techniques to facilitate fission product capture in a reactor system at the source of the emission, such as at or in proximity to an example pipe connection and/or pump shaft.

### SUMMARY

In one example, a fission product trap for a pipe connection of a reactor system is disclosed. The trap includes a porous container mounted about the pipe connection and having an absorbing material contained therein that is configured to collect fission products emitted from the pipe connection. The trap further includes an assembly encompassing the porous container and defining a volume about the porous container and the pipe connection.

In another example, the absorbing material includes loose activated carbon, silver zeolite, carbon nanostructures and/or any other material that is configured to collect and trap fission products therein.

In another example, the fission products include radioactive iodine, tritium, tellurium, cesium, bromine and/or other fission products.

In another example, the porous container encompasses the pipe connection and forms a sealed volume therearound.

In another example, the pipe connection may be defined by a pair of flanges. In this regard, the porous container may define a recessed band configured to receive the pair of flanges therein.

In another example, the porous container may include an inner shell that defines the recessed band, and an outer shell arranged about the inner shell and defining a holding space therebetween. The absorbing material may therefore be arranged in the holding space.

In another example, the inner shell may define a plurality of holes positioned within the recessed band.

In another example, the assembly includes a sleeve arranged over the porous container and the pipe connection. The assembly may further include a pair of clamping assemblies. Each clamping assembly of the pair of clamping assemblies may be arranged along an end of the sleeve and configured to define a sealed connection with a respective pipe associated with the pipe connection.

In another example, each clamping assembly of the pair of clamping assemblies includes a clamping shaft having a threaded outer surface and an axial passage therethrough such that the axial passage is configured to receive the respective pipe. Each clamping assembly of pair of clamping assemblies further includes a gripping element abutting the clamping shaft along an outer surface of the respective pipe. Each clamping assembly of pair of clamping assemblies includes a clamping nut having a complementary threaded inner surface configured to threadably engage the threaded outer surface of the clamping shaft.

In another example, in response to a threaded engagement of the clamping shaft and the clamping nut toward one another, the gripping element may be compressed therebetween and encouraged toward the outer surface of the respective pipe to establish a sealed boundary of the clamping assembly.

In another example, a system is disclosed. The system may include a fission product trap, such as any of the fission product traps disclosed herein. The system may further include a first pipe and a second pipe. The first and second pipe cooperate to define the pipe connection.

In another example, a fission product trap for a pump shaft of a pump of a reactor system is disclosed. The trap includes a porous container mounted about the pump shaft and having an absorbing material contained therein that is configured to collect fission products emitted from along the pump shaft. The trap further includes an assembly encompassing the porous container and defining a volume about the porous container and the pump shaft.

In another example, the absorbing material includes loose activated carbon, silver zeolite, carbon nanostructures and/or any other material that is configured to collect and trap fission products therein.

In another example, the fission products include radioactive iodine, tritium, tellurium, cesium, bromine and/or other fission products.

In another example, the trap further includes at least one bearing mounted in a plate and receiving the pump shaft therethrough. The at least one bearing may be configured to permit rotation of the pump shaft while constraining radial movement of the pump shaft relative to the gas tight assembly.

In another example, the porous container includes three sub-containers, each sub-container separated from one another by a respective one of the at least one bearing.

In another example, the pump shaft is associated with a mechanical seal. Accordingly, a first sub container of the porous container may be configured to fit about a periphery of the mechanical seal and extend along and separated from the pump shaft.

In another example, the assembly may be configured to form a volume about the pump shaft and includes a sleeve arranged over the porous container and the pump shaft. The gas-tight assembly further includes a pair of opposing flanges, wherein the sleeve is gasket-sealed to each flange of the pair of opposing flanges at respective ends of the sleeve.

In another example, a system is disclosed. The system includes a trap, such as any of the traps disclosed herein. The system further includes the pump shaft, and associated pump impeller and pump motor.

In another example, a method for capturing fission products from a reactor system is disclosed. The method includes operating the reactor system including generating the fission products. The method further includes emitting the fission products at one or both of a pipe connection or pump shaft of the reactor system. The method further includes receiving the fission products into an absorbing material arranged about the pipe connection or the pump shaft of the reactor system. The absorbing material may be arranged in a porous container mounted about the pipe connection or the pump shaft.

In addition to the example aspects described above, further aspects and examples will become apparent by reference to the drawings and by study of the following description.

### BRIEF DESCRIPTION OF THE DRAWINGS

FIG. 1 depicts an example molten salt reactor system.

FIG. 2 depicts an isometric view of a system including an example fission product trap.

FIG. 3 depicts an exploded view of the system of FIG. 2.

FIG. 4 depicts a cross-sectional view of the example fission product trap of FIG. 2, taken along line 4-4 of FIG. 2.

FIG. 5A depicts detail 5A-5A of FIG. 4.

FIG. 5B depicts detail 5B-5B of FIG. 4.

FIG. 6 depicts detail 6-6 of FIG. 4

FIG. 6A depicts detail 6A-6A of FIG. 6.

FIG. 7 depicts a cross-sectional view of the example fission product trap of FIG. 2, taken along line 7-7 of FIG. 2.

FIG. 8 depicts an isometric view of another system including another example fission product trap.

FIG. 9 depicts an exploded view of the system of FIG. 8.

FIG. 9A depicts a porous container of the fission product trap of FIG. 9.

FIG. 9B depicts a cross-sectional view of the porous container of FIG. 9A, taken along line 9B-9B of FIG. 9A.

FIG. 10 depicts a cross-sectional view of the example fission product trap of FIG. 8, take along line 10-10 of FIG. 8.

FIG. 11 depicts detail 11-11 of FIG. 10.

FIG. 11A depicts detail 11A-11A of FIG. 11.

FIG. 12 depicts a flow diagram of an example method for capturing fission products from a reactor system.

The use of cross-hatching or shading in the accompanying figures is generally provided to clarify the boundaries between adjacent elements and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to fission product traps for a reactor system, such as a molten salt reactor system. A molten reactor system may broadly include any of a variety of molten salt reactors that are used to produce nuclear power in part by utilizing molten salts as a nuclear fuel in place of the conventional solid fuels used in light water reactors. In molten salt reactors, fission reactions occur within a molten salt composition housed within a reactor vessel. Such fission reactors may produce certain byproducts that exhibit radioactive properties, such as producing radioactive iodine. While molten salt reactor systems are designed to contain such fission products within process equipment (e.g., within pipes, vessels, heat exchanges, and so on), it is possible that the molten salt reactor system could emit a measurable amount of fission products from certain locations with the system; namely, from a connection or junction between two pipes, and/or from or along a pump shaft of a pump of the reactor system (including from components associated with the pump shaft, such as certain mechanical seals). Measurable fission products that exhibit radioactive properties may cause certain undesirable environmental, health, and safety conditions within the reactor system. Conventional techniques that contain emitted fission products within a reactor containment vessel (e.g., that contains all or substantially all of the reactor system) fail to mitigate and capture fission products at the source of emission, which can thus lead to undesirable build up of fission products within the containment vessel.

To mitigate these and other challenges, the fission product traps of the present disclosure may be arranged to trap and capture fission products at or in proximity to the source of emission, such as at or in proximity to a pipe connection or junction and/or a pump shaft of a pump of the reactor system. It will be appreciated that while example traps are described herein with respect to the trapping fission products at or in proximity to the pipe connection and/or the pump shaft of a molten salt reactor, in other examples, the fission product traps of the present disclosure may be adapted to trap fission products emitted from substantially any component, juncture, interface, leak point, and so on within substantially any reactor system. As disclosed herein, the fission product trap may include a porous container having an absorbing material contained therein. The porous container may be configured to be mounted or fit around or encompass some or all of a given pipe connection or pump shaft of the reactor system. The absorbing material may include loose activated carbon, silver zeolite and/or carbon nanostructures that are configured to collect and retain the fission products, such as a radioactive iodine, tritium, tellurium, cesium, bromine, and/or other fission products therein. The porous container is mountable to the pipe connection or along the pump shaft in a manner that allows the fission products to be captured by the absorbing material before the fission products can diffuse to the rest of the reactor system (and eventually the environment).

In order to further mitigate the diffusion of fission products, the fission product trap may further include an assembly encompassing the porous container and defining a volume about the porous container and the pipe connection or pump shaft. In some cases, such assembly may be a gas-tight assembly that defines a sealed volume about the porous container. In this regard, the trap may allow for the absorption of the radioactive products in a sealed, low or near-zero O₂ environment. The assembly further defines a barrier between the fission products and the environment of the reactor containment vessel in order to mitigate release of the products into the broader containment space. In some cases, the assembly may be associated with one or more systems to purge the gas of the sealed volume of O₂ and to provide an inert gas to the sealed volume.

It will be appreciated that the assembly may be structurally configured in any appropriate manner adapted to provide a volume about certain points in the reactor system that may emit fission products. As one example, where the trap is configured to trap fission products emitted from a pipe connection, the assembly may be integrated with one or more pipe clamps in order to optionally define a seal between the assembly and one or more pipes that define the pipe connection. In another example, the assembly may be integrated with one or more flanges and gaskets in order to optionally define a seal between the gas-tight assembly and one or more components of a pump of the reactor system, such as defining a seal between an impeller housing and a pump motor of the pump. In other examples, other implementations of the assembly are contemplated herein, including implementations in which the assembly forms a gas-tight assembly.

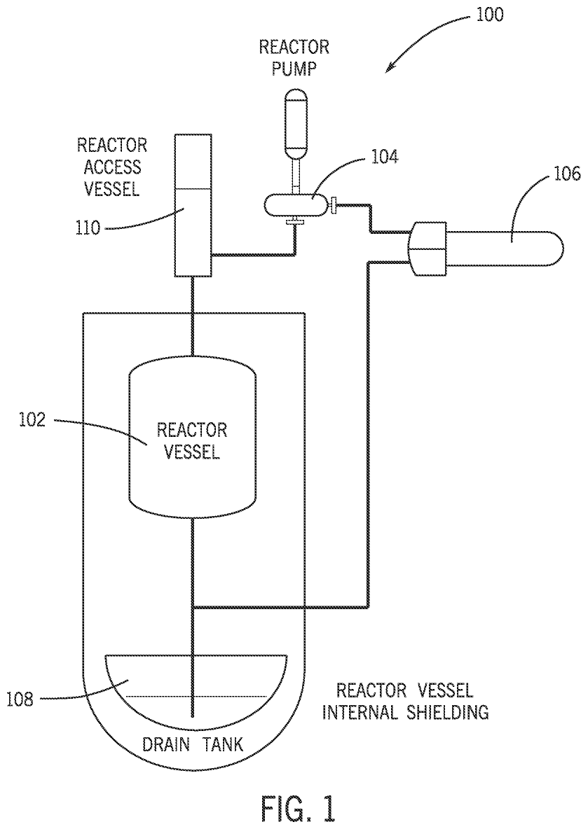

Turning to the drawings, for purposes of illustration, FIG. 1 depicts a schematic representation of an example molten salt reactor system 100. The molten salt reactor system 100 may implement and include any of the fission product traps described herein. As will be understood and appreciated, the example shown in FIG. 1 represents merely one example environment in which the fission product traps may be utilized. It will be understood that the fission product traps described herein may be used in and with substantially any other environment or operating system, such as those associated with other systems in which fission products are emitted.

In various embodiments, a molten salt reactor system 100 utilizes fuel salt enriched with uranium (e.g., high-assay low-enriched uranium) to create thermal power via nuclear fission reactions. In at least one embodiment, the composition of the fuel salt may be LiF—BeF₂—UF₄, though other compositions of fuel salts may be utilized as fuel salts within the reactor system 100. The fuel salt within the system 100 is heated to high temperatures (about 700° C.) and melts as the system 100 is heated. In several embodiments, the molten salt reactor system 100 includes a reactor vessel 102 where the nuclear reactions occur within the molten fuel salt, a fuel salt pump 104 that pumps the molten fuel salt to a heat exchanger 106, such that the molten fuel salt re-enters the reactor vessel after flowing through the heat exchanger, and piping in between each component. The molten salt reactor system 100 may also include additional components, such as, but not limited to, drain tank 108 and reactor access vessel 110. The drain tank 108 may be configured to store the fuel salt once the fuel salt is in the reactor system 100 but in a subcritical state, and also acts as storage for the fuel salt if power is lost in the system 100. The reactor access vessel may be configured to allow for introduction of small pellets of uranium fluoride (UF₄) to the system 100 as necessary to bring the reactor to a critical state and compensate for depletion of fissile material.

In several examples, the fission product traps disclosed herein may be utilized to collect fission products emitted from a pipe connection and/or a pump shaft of the system 100. For example, a given fission product trap may be configured to capture fission products emitted from a pipe connection. Such fission product trap may therefore be arranged at a connection or juncture of any two pipes of the system 100, such as a connection of two pipes between the reactor vessel 102 and the reactor access vessel 110, a connection of two pipes between the reactor access vessel 110 and the reactor pump 104, a connection of two pipes between the reactor pump 104 and the heat exchanger 106, a connection of two pipes between the heat exchanger 106 and the drain tank 108, a connection of two pipes between the drain tank 108 and the reactor vessel 102, and/or substantially any other pipe connection of the system 100. As another example, a given fission product trap may be configured to capture fission products emitted from along a pump shaft, such as a shaft of the reactor pump 104. In this regard, such fission product traps may be arranged and integrated with the reactor pump 104 (or other pump) of the system 100. In other examples, the fission product traps disclosed herein may be integrated with any other assembly or component of the system 100 that may emit fission products, such as radioactive iodine.

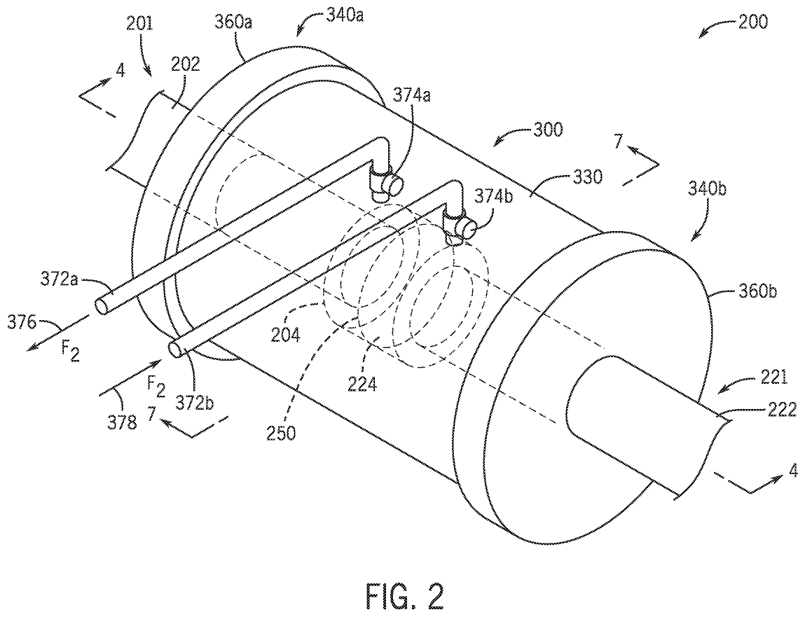

FIG. 2 depicts an isometric view of a system 200 including an example fission product trap 300. The system 200 may include a pipe connection or juncture of the system 100. The system 200, as illustrated in FIGS. 2-4, may include a first pipe 201 and a second pipe 221. The first and second pipes 201, 221 may be arranged abutting one another or otherwise arranged end-to-end in order to define a pipe connection 250 therebetween. In some cases, a gasket 252 may be arranged between the first and second pipes 201, 221 in order to establish the pipe connection 250 as being gasket-sealed. Notwithstanding the pipe connection 250 being sealed (including being optionally gasket-sealed), the pipe connection 250 may in some circumstances, emit fission products therefrom, such as emitting a radioactive iodine, tritium, tellurium, cesium, bromine and/or other fission products therefrom. The trap 300, as explained in greater detail herein, operates to trap fission products emitted from the pipe connection 250.

While the system 200 may include any appropriate arrangement of pipes, fittings, seals and the like based on the function of the system 200 with the reactor system 100, the system 200 is shown in FIGS. 2-4 with the first pipe 201 including a pipe segment 202 and a flange 204. The pipe segment 202 may have a generally tubular structure that defines a run or length of the pipe 201. The flange 204 may be coupled to an end of the pipe segment 202 and configured for removably securing the pipe 201 to another pipe. The pipe segment 202 and the flange 204 may cooperate to define a passage 206 therethrough. The passage 206 may be configured to carry a molten salt material at high temperature. FIGS. 2-4 further shown the first pipe 201 with the flange 204 defining a flange face 208 and flange holes 210 extending through the face 208 and being circumferentially spaced about the passage 206. The second pipe 221 may be substantially analogous to the first pipe 201 and include a pipe segment 222, a flange 224, a passage 226, a flange face 228, and flange holes 230.

In one example, the flange face 208 of the first pipe 201 and the flange face 228 of the second pipe 221 are arranged facing one another. The gasket 252 may be positioned between the flange faces 208, 228. In this regard, fasteners 212 may be positioned through corresponding holes of the flange holes 210 of the first pipe 201 and flange holes 230 of the second pipe 221. Nuts 232 or other securing elements may in turn, be threadably engaged with the fasteners 212 in order to encourage the faces 208, 228 toward one another and to compress the gasket 252 therebetween. The compression of the gasket 252 between the faces 208, 228 may define a gasket-sealed connection between the pipes 201, 221 at the pipe connection 250.

While the example of FIGS. 2-4 shows the pipes 201, 221 as being gasket-sealed to one another, in other cases, the pipes 201, 221 may be welded to one another. For the sake of non-limiting illustration, the flanges 204, 224 of each of the pipes 201, 221 may be omitted. In turn, the ends of each of the respective pipe segments 202, 222 may be welded to one another in order to establish the pipe connection 250 as a welded connection or welded seal. In this regard, while FIGS. 2-4 show and describe the fission product trap as being configured to trap fission products that are emitted from a gasket-sealed pipe connection, in other cases, as contemplated herein, the fission product trap may be configured to trap fission products from a welded connection.

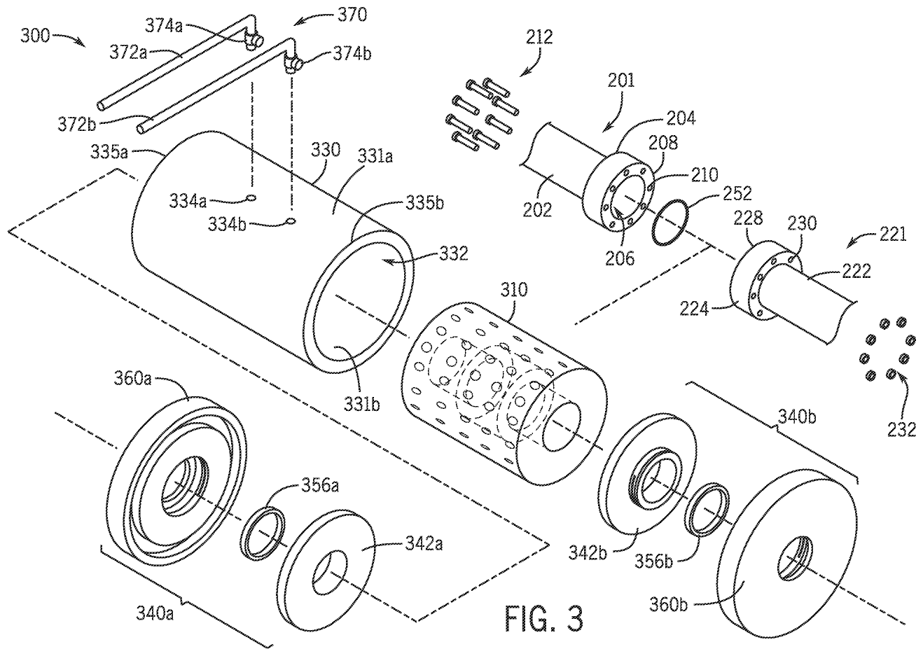

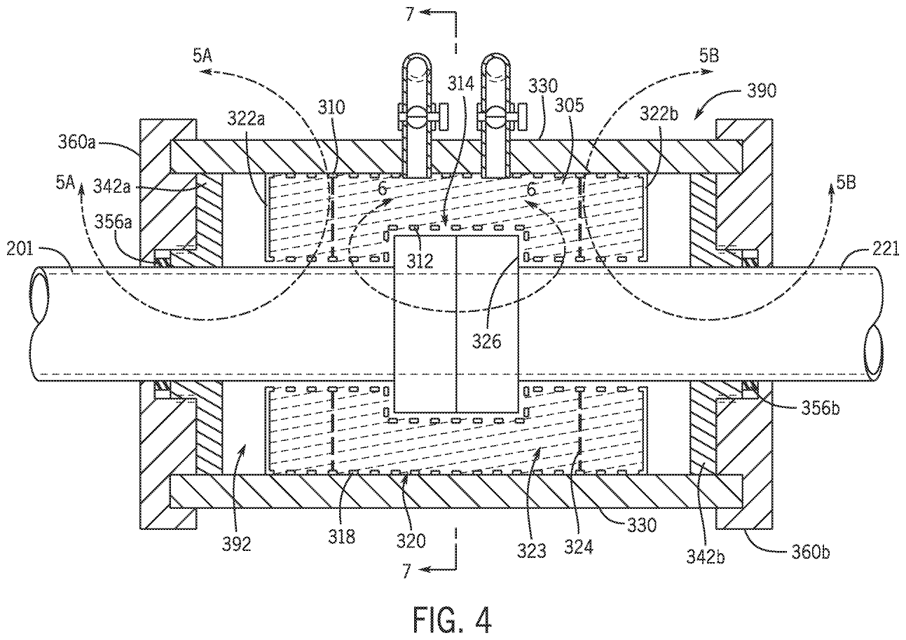

As shown in FIGS. 3 and 4, the fission product trap 300 may broadly include a porous container 310 and an assembly 390. The porous container 310 is configured for mounting about the pipe connection 250 and has an absorbing material 305 contained therein. The absorbing material 305 may be loose activated carbon, silver zeolite, carbon nanostructures, or other materials of various structural configurations that are configured to collect and trap fission products therein, such as collecting and trapping a radioactive iodine (and/or other fission products) from the pipe connection 250. The assembly 390 may include a collection of components, as described in greater detail below, that collectively operate to define a volume 392 about the porous container 310 and the pipe connection 250. In this regard, the absorbing material 305 may operate to collect the fission products emitted from the pipe connection 250, and the assembly 390 may operate to mitigate the release of any fission products or gasses from the region of the absorbing material 305 by optionally defining a gas-tight barrier about the pipe connection 250.

The porous container 310 may operate to define a basket or holding structure for the absorbing material 305 that also permits the intrusion of fission products into the container 310 such that fission products may be collected to absorbing material 305. In one example, the porous container 310 may include an inner shell 312, an outer shell 318, and end pieces 322a, 322b. Broadly, the inner shell 312, the outer shell 318, and the ends pieces 322a, 322b may collectively define cylindrical-type structure that fits about and generally encompasses the pipe connection 250. For example, the inner shell 312 may include one or more material sections that define an interior surface 313 of the porous container 310. Ends of the cylindrical-type shape defined by the porous container may be established by the end pieces 322a, 322b. The inner shell 312, the outer shell 318, and the end pieces 322a, 322b may cooperate to define a holding space 323 of the porous container 310. The holding space 323 may be configured to house the absorbing material 305 therein, including being configured to house a sufficient amount of absorbing material 305 in order for the absorbing material 305 to collectively be capable of trapping fission products for a period of years, such as a period of one year, a period of three years, a period of five years, or longer. Optional internal supports 324 may be arranged within the holding space 323 in order to connect the inner shell 312, the outer shell 318, and the end pieces 322a, 322b to one another. In some cases, fasteners of various types may also be used to couple the inner shell 312, the outer shell 318, and the end pieces 322a, 322b to one another.

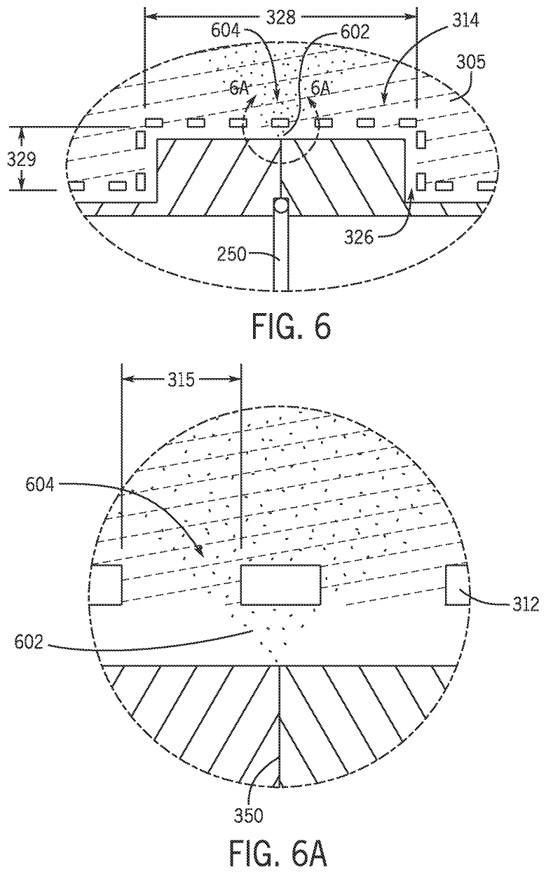

The inner shell 312 may define a plurality of holes 314 through a thickness of the material that defines the inner shell 312. Each hole of the plurality of holes 314 may have a hole diameter 315, as shown in greater detail with reference to FIGS. 6 and 6A herein. The hole diameter 315 may be sized in order to permit passage of (and adequate flow of) fission products through the inner shell 312 for absorption by the absorbing material 305. The hole diameter 315 may further be sized in order to contain the absorbing material 305 in the porous container 310 such that absorbing material 305 is not readily released therefrom. The outer shell 318 may define an outer surface having a plurality of holes 320 have similar properties and dimensions as the plurality of holes 314 of the inner shell 312. While the plurality of holes 314, 320 are shown in FIGS. 3 and 4 as having a generally consistent size and shape, this is not required. It will be appreciated that the holes of the plurality of holes 314, 320 may be of any sufficient size and shape, including non-uniform and non-symmetrical shapes, any of which may or may not be uniformly distributed along the material of the respective shells.

With reference to FIGS. 4 and 6, the porous container 310 is also shown as including a recessed band 326. The recessed band 326 may be configured to receive some or all of the pipe connection 250. For example, the recessed band 326 may be configured to fit around an entire periphery of the pipe connection 250 such that the pipe connection 250 fits within and is fully encompassed about its perimeter by the porous container 310. The size and shape of the recessed band 326 may be adapted based on the size, shape and service of pipe connection about which the trap 300 is mounted. In the example of FIGS. 4-7, the recessed band 326 may be a generally cylindrical void having an axial dimension 328 and a radial dimension 329. The axial dimension 328 may be configured to correspond to the collective thickness of the flanges 204, 224, describe above, such that both flanges 204, 224 may fit at least partially within the recessed band 326. Further, the radial dimension 329 may be configured to correspond to the radial dimension of the flanges 204, 224 (relative to an outer surface of the pipe segments 202, 222) in order to further accommodate fitting both flanges 204, 224 at least partially within the recessed band 326.

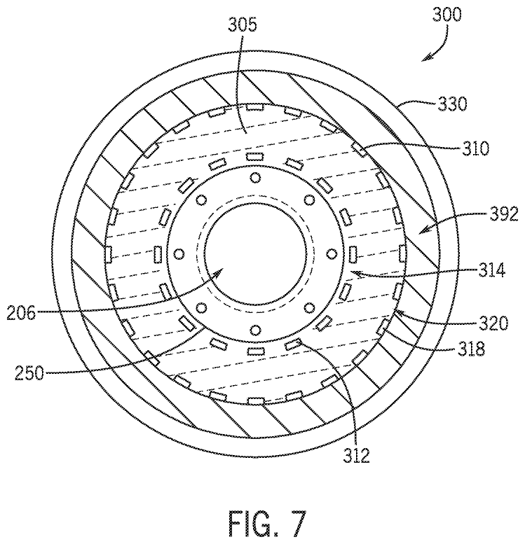

As described herein, the porous container 310 may be enclosed in a volume 392 that is defined by the assembly 390. The assembly 390 may include any appropriate combination of components and subassemblies appropriate to form and maintain the volume 392 about the porous container 310, including components and subassemblies that operate to form the volume 392 as a sealed volume. In the example of FIGS. 4-7, the assembly 390 is shown as including a sleeve 330 and a pair of clamping assemblies, such as a first clamping assembly 340a and a second clamping assembly 340b. The sleeve 330 may be a pipe segment other cylindrical structure that operates to form a jacket about the porous container 310. For example, and as shown in FIGS. 3 and 7, the sleeve 340 may define an outer surface 331a, an inner surface 331b, and an inner volume 332 running along the inner surface 331b. The sleeve 330 may be further defined by first and second sleeve ends 335a, 335b that define terminal opposing ends of the sleeve 330. The sleeve 330 is further shown as including first and second ports 334a, 334b. The first and second ports 334a, 334b may be couplable with certain valving and tubing, as described in greater detail below, in order to permit purging of the volume 392 with an inert gas.

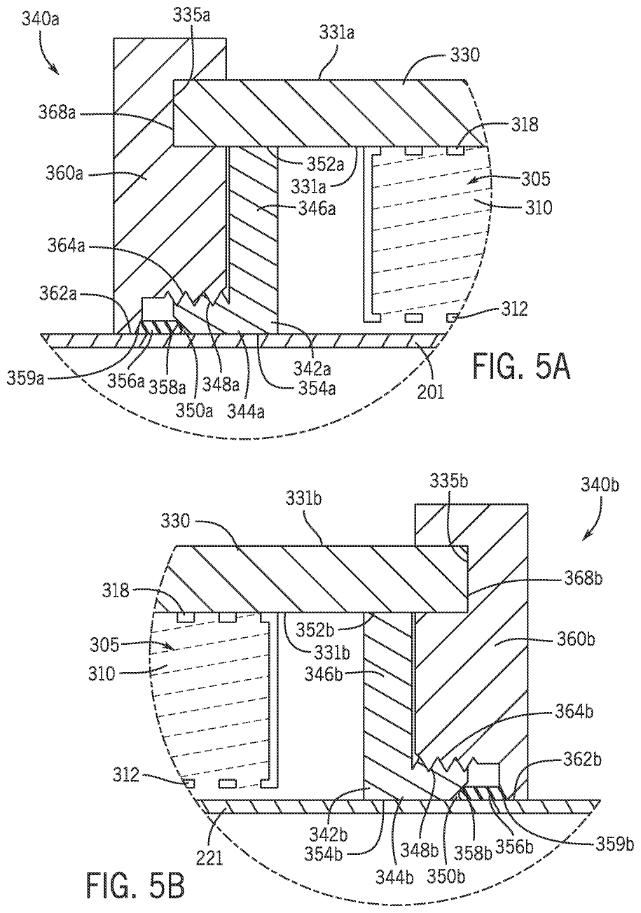

With reference to FIGS. 3 and 5A, the first clamping assembly 340a is shown as including a clamping shaft 342a, a gripping element 356a, and a clamping nut 360a. The clamping shaft 342a, the gripping element 356a, and the clamping nut 360a may cooperate to define a sealed connection between the first sleeve end 335a and a pipe (e.g., pipe 201) of a pipe connection (e.g., of the pipe connection 250). With reference to the clamping shaft 342a, the clamping shaft 342a is shown as including a shaft portion 344a and a radial portion 346a. The shaft portion 344a may be a tubular structure having an axial passage 354a that is configured to fit onto (including forming a press fit with) the example pipe of the pipe connection. The shaft portion 344a may further include a threaded outer surface 348a. The threaded outer surface 348a may extend about a complete periphery of the shaft portion 344a. The shaft portion 344a may further include a nose portion that defines a wedge feature 350a. The wedge feature 350a may be a contoured surface or tip of the shaft portion 344a that is configured to engage the gripping element 356a for forming the sealed connection between the pipe and sleeve 330, as described in greater detail herein. The radial portion 346a may extend integrally from the shaft portion 344a and radially away from the axial passage 354a. The radial portion 346a may include a ledge 352a to facilitate seating of the sleeve 330 on the first clamping assembly 340a, as described herein.

With continued reference to FIGS. 4-6, the first clamping assembly 340a is further shown including the gripping element 356a. The gripping element 356a may be a cylindrical or ring-like component that operates to grip into the pipe upon the movement of the clamping shaft 342a and the clamping nut 360a toward one another in order to facilitate the establishment of the sealed connection between the pipe and the sleeve 330. For example, the gripping element 356a is shown as including a first engagement surface 358a and a second engagement surface 359a. The first engagement surface 358a may be configured to engage a portion of the clamping shaft 342, whereas the second engagement surface 359a may be configured to engage a portion of the clamping nut 360a. The first and second engagement surfaces 358a, 359a may be tailored or contoured such that that movement of the clamping shaft 342 and the clamping nut 360a toward one another encourages one of the first or the second engagement surfaces 358a, 359a to move toward, and optionally partially into, the pipe for forming the sealed connection described herein.

The clamping assembly 340a is further shown as including the clamping nut 360a. The clamping nut 360a may define a passage 362a therethrough having complementary threads 364a therein. The clamping nut 360a is further shown as having a wedge feature 366a arranged in the passage 362a and being configured for engagement with the gripping element 356a. The clamping nut 360a is further shown as including a receiving cut 368a configured for receiving the sleeve 330 therein. The receiving cut 368a may extend about a complete periphery of the clamping nut 360a.

It will be appreciated that the second clamping assembly 340b may be substantially analogous to the first clamping assembly 340a, as shown in FIG. 5B, and may therefore include: a clamping shaft 342b, a shaft portion 344b, a radial portion 346b, a threaded outer surface 348b, a wedge feature 350b, a ledge 352b, an axial passage 354b, a gripping element 356b, a first engagement surface 358b, a second engagement surface 359b, a clamping nut 360b, a passage 362b, complementary threads 364b, a wedge feature 366b, and a receiving cut 368b; redundant explanation of which is omitted here for clarity.

With reference to FIGS. 3 and 4, the trap 300 is further shown as including or otherwise being associated with a gas management system 370. The gas management system 370 may operate generally to purge the volume 392 of oxygen and to replace the oxygen with an inert gas. In the example of FIGS. 3 and 4, the gas management system 370 is shown as including tubing 372a, 372b with corresponding valves 374a, 374b. In one example, the tubing 372a and corresponding valve 374a may be coupled with the volume 392 via the first port 334a. The tubing 372a may be coupled with a vacuum system or the like that is configured to draw a vacuum flow 376 from the volume 392 in order to remove oxygen from the volume 392. Further, the tubing 372b and corresponding valve 374b may be coupled with the volume 392 via the second port 344b. The tubing 372b may be coupled with an inert gas source or the like that is configured to provide an inert gas flow 378 to the volume 392.

The trap 300 may be coupled such that the porous container 310 is mounted about the pipe connection 250. For example, porous container 310 may be positioned adjacent the pipe connection with the flanges 204, 224 being received by and at least partially into the recessed band 326 of the porous container 310. In some cases, as described herein, the porous container 310 may be a multi-component or composite structure that is formed by snapping or fastening individual components (e.g., various shells, end pieces, and internal supports) to one another. In this regard, it will be appreciated that in some examples, the trap 300 is coupled with the pipe connection 250 by arranging a portion of the porous container 310, such a portion of the inner shell 312 about the pipe connection 250. The absorbing material 305 may be arranged about the inner shell 312 and enclosed in the holding space 323 of the porous container may connecting additional portions of the porous container 310 to one another to define the completed structure. In this regard, the porous container 310 can be assembled over the pipe connection 250 without necessarily separating the pipes of the pipe connection 250 from one another.

The trap 300 may be further coupled by assembling the assembly 390 about the porous container 310 and the pipe connection 250. For example, the sleeve 330 may be slid over the porous container 310 and the pipe connection 250 such that the porous container 310 and the pipe connection 250 are arranged entirely with the inner volume 332 of the sleeve 330. The sleeve 330 may in turn be sealed to the first pipe 201 via the first clamping assembly 340a, and may be sealed to the second pipe 221 via the second clamping assembly 340b. The sealing of the sleeve 330 to the first pipe 201 and the second pipe 221 may establish the volume 392 about the porous container 310 and the pipe connection 250.

To facilitate the establishment of the volume 392, and as shown in FIG. 5 with respect to the first clamping assembly 340a, the shaft portion 344a may receive the pipe 201 within and through the axial passage 354a. The sleeve 330 may rest on the radial portion 346a of the clamping shaft 342a, such as sitting on the ledge 352a. The gripping element 356a is arranged on the pipe 201 such that the first engagement surface 358a of the gripping element 356a is positioned adjacent the wedge feature 350a of the clamping shaft 342a. Further, the clamping nut 360a is arranged such that the pipe 201 is received by passage 362a. The clamping nut 360a is advanced along the pipe 201 to receive the first end 335a of the sleeve in the receiving cut 368a. The clamping nut 360a is further advanced along the pipe 201 to threadably engage the complementary threads 364a with the threaded outer surface 348a of the clamping shaft 342a. The clamping nut 360a is further advanced along the pipe 201 so that the wedge feature 366a is positioned adjacent the second engagement surface 359a of the gripping element 356. The clamping nut 360a may be threadably engaged with the clamping shaft 342a in manner that causes the clamping shaft 342a and the clamping nut 360a to move toward one another. Upon the clamping shaft 342a and the clamping nut 360a moving toward one another, the sleeve 330 may be encouraged to move deeper into the receiving cut 368a. Further upon the clamping shaft 342a and the clamping nut 360a moving toward one another, the wedge feature 350a of the clamping shaft 342a may engage the first engagement surface 358a of the gripping element 356a and the wedge feature 366a of the clamping nut 360a may engage the second engagement surface 359a of the gripping element 356a such that the gripping element 356a is compressed therebetween. The first and second engagement surfaces 358a, 359a may be configured such that the compression of the gripping element 356a in this regard encourages at least one of the first or second engagement surface 358a, 358b toward an outer surface of the pipe in order to define a seal therewith. It will be appreciated that the second clamping assembly 340b may operate to establish a seal between the sleeve 330 and the pipe in a substantially analogous manner. In other examples, other types and configurations of a clamp seal may be used to establish one or both of the seals between the sleeve 330 and the respective pipe, including examples in which one or both of the gripping elements 356a, 356b may be omitted.

In operation, and as shown in relation to FIGS. 6 and 6A, radioactive iodine 602 (and/or other fission product, including, without limitation tritium, tellurium, cesium, or bromine) may be emitted from the pipe connection 250. The porous container 310 including the absorbent material 305 may be position adjacent the pipe connection 250. In this regard, the radioactive iodine 602 may travel from the pipe connection 250 and toward the porous container 310. The radioactive iodine 602 may enter the porous container 310 via the plurality of inner holes 314. As shown in FIG. 6A, the radioactive iodine 602 may define a gradient 604 such that the radioactive iodine 602 is dispersed within and collected by the absorbing material 305. By collecting the radioactive iodine 602 in the absorbing material 305, the fission product trap 300 may operate to reduce the release of fission products into the broader containment vessel or region of the reactor system.

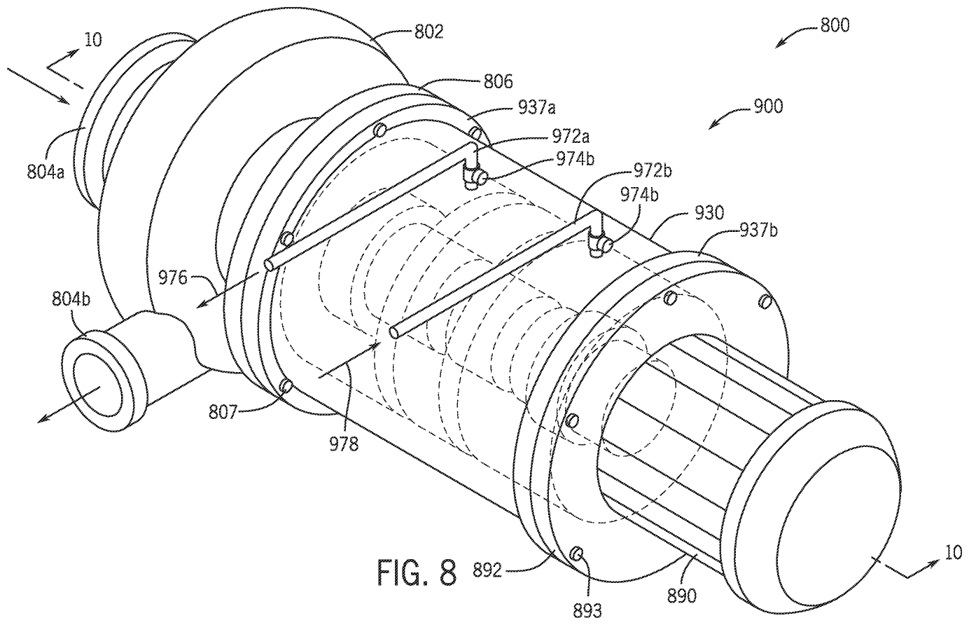

Turning to another example, FIG. 8 depicts an isometric view of a system 800 including an example fission product trap 900. The system 800 may be or include one or more components associated with the pump 104 of the system 100 shown in FIG. 1. Broadly, and as shown in FIGS. 8-10, the fission product trap 900 may be operable to collect and capture fission products emitted from one or more components of the system 800, such as fission products emitted from along a pump shaft or mechanical seal, as described herein. The system 800, as illustrated in FIGS. 8-10, may include at least an impeller housing 802, a mechanical seal 812, a pump shaft 820, a coupler 824, a motor shaft 894, and a pump motor 890. The pump motor 890 may operate to rotate the motor shaft 894. The rotation of the motor shaft 894 may cause a corresponding rotation of the coupler 824 and the pump shaft 820. The pump shaft 820 may extend through the mechanical seal 812, and rotate therein, with such rotation of the pump shaft 820 causing a corresponding rotation of an impeller arranged within the impeller housing 802. The impeller housing 802 may contain material, such as a molten salt or other material, which may exhibit radioactive properties. Accordingly, it will be appreciated that fission products could be emitted from several points in the system 800 such as from the mechanical seal 812 and/or along the pump shaft 820, such as any of the fission products contemplated herein. The trap 900 described herein is configured to mount about the pump shaft 820 (including mounting about the mechanical seal 812) in order to capture fission products at the source and to mitigate the buildup of fission products within a containment vessel or other containment structure of the reactor system.

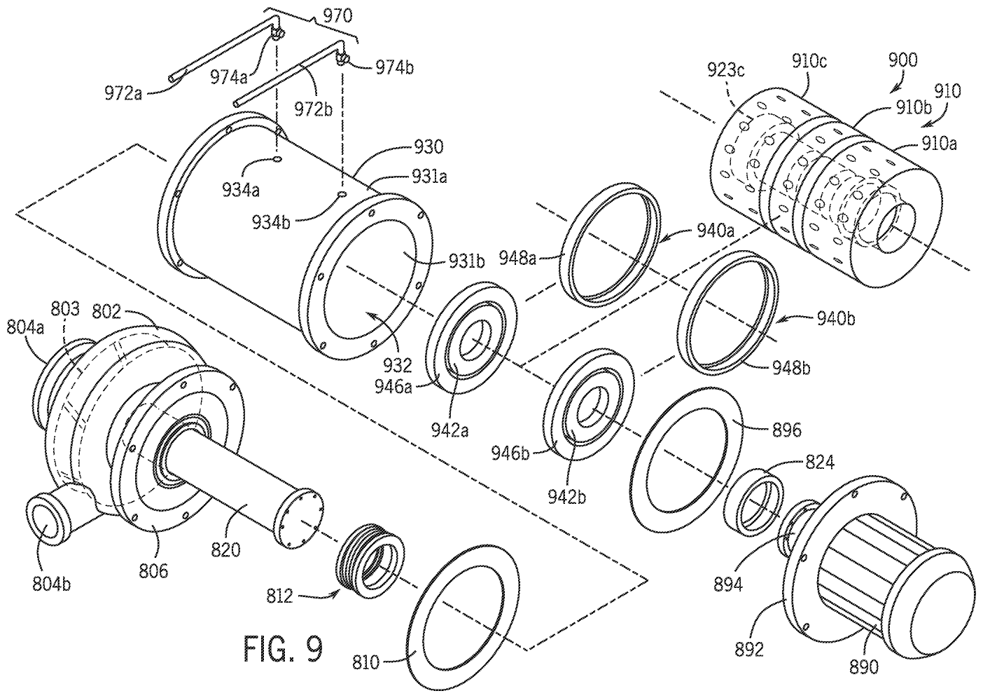

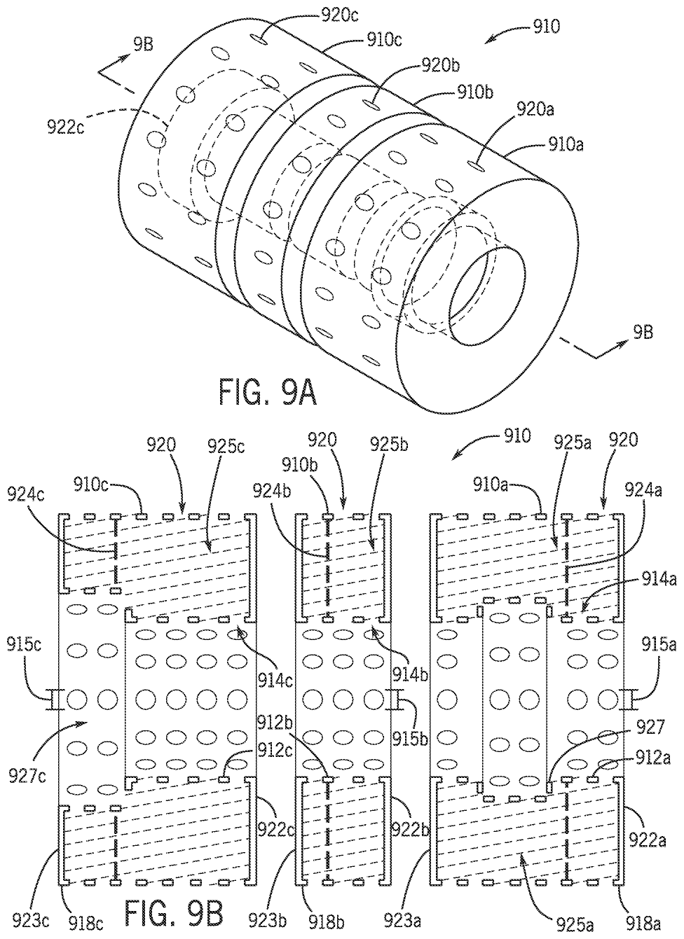

While the system 800 may include any appropriate arrangement of components, subassemblies, pipes, fittings, and the like based on the function and configuration of the pump, the system 800 is shown in FIGS. 8-10 with the impeller housing 802 embodied as a centrifugal pump. It will be appreciated that the trap 900 disclosed herein is not limited to being arranged with centrifugal pumps, and may be adapted to any appropriate pump that is implemented with the reactor system 100, according to the techniques described herein. In the example of FIGS. 8-10, the impeller housing 802 is shown defining an impeller housing volume 803. The pump shaft 820 may extend into the impeller housing volume 803 and mount with an impeller therein in order to facilitate increasing a pressure of a fluid passing through the impeller housing 802. The impeller housing 802 is further shown in FIGS. 8 and 9 for purposes of illustration as including fluid connections 804a, 804b, which may include flanges, and that define a respective inlet and outlet for process fluid being pumped through the impeller housing 802. The impeller housing 802 is further shown as including a housing flange 806. As described in greater detail herein, the housing flange 806 may be configured to define a mount for the trap 900.

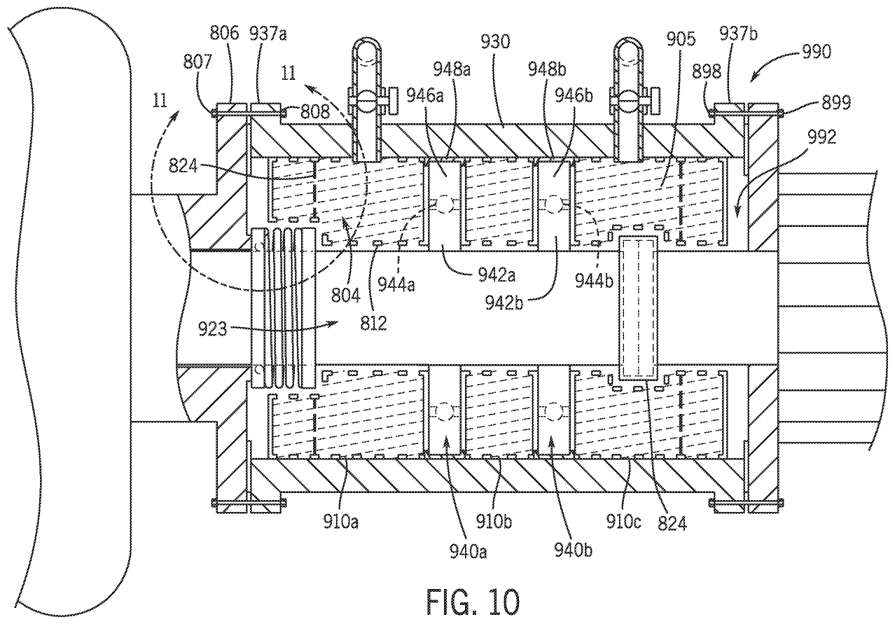

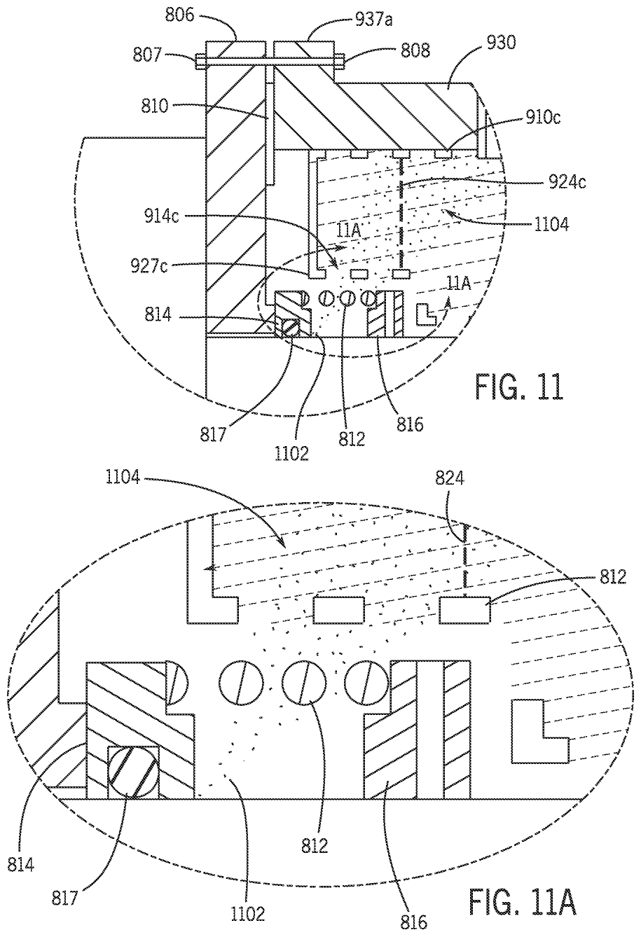

As shown in relation to FIGS. 10 and 11, the system 800 includes the mechanical seal 812 adjacent the impeller housing 802 and outside of the impeller volume 803. The mechanical seal 812 is shown in FIGS. 9 and 10 as including a first subassembly 814, a second subassembly 816, a biasing element 812, and a sealing element 817. The first and second subassemblies 814, 816 may cooperate to define a shaft-type seal about the pump shaft 820 that forms a liquid-and gas-tight barrier between the impeller housing volume 803 and the pump shaft 820. The first and second subassemblies 814, 816 may further be configured to maintain such liquid-and gas-tight barrier while the pump shaft 820 rotates. As one example, the biasing element 812 may bias the subassemblies 814, 816 away from one another and cause the sealing element 817 to maintain pressure on the shaft 820 while the shaft 820 rotates, thereby maintaining the shaft seal during operation. It will be appreciated that the components of the mechanical seal 812 are presented for purposes of illustration; any appropriate mechanical shaft-type seal may be used. Example types of mechanical seal which may be used include, without limitation, balanced seals, unbalanced sealed, pusher seals, non-pusher seals, conventional seals, cartridge seals, among other possibilities.

As shown in FIGS. 9-10, the fission product trap 900 may broadly include a porous container 910 and an assembly 990. The porous container 910 is configured for mounting about the pump shaft 820 and has an absorbing material 905 contained therein. The absorbing material 905 may be loose activated carbon, silver zeolite, and/or carbon nanostructure and/or other material that is configured to collect and trap fission products therein, such as collecting and trapping a radioactive iodine (or other fission product) that is emitted generally from along the pump shaft 820. The assembly 990 may include a collection of components, as described in greater detail below, that collectively operate to define a volume 992 about the porous container 910 and the pump shaft 820. In this regard, the absorbing material 905 may operate to collection the fission products emitted from along the pump shaft 820, and the assembly 990 may operate to mitigate the release of any fission products or gasses from the region of the absorbing material 905.

The porous container 910 may operate to define a basket or holding structure for the absorbing material 905 that also permits the intrusion of fission products into the container 910 such that fission products may be collected to absorbing material 905. The porous container 910 may be constructed in a manner that accommodates the configuration and components of the pump with which the porous container is arranged. In the example of FIGS. 9-10, the porous container 910 is shown as a multi-piece container including three sub-containers, e.g., a first sub-container 910a, a second sub-container 910b, and a third sub-container 910c. In other cases, more or fewer sub-containers may be used. Each of the sub-containers 910a-910c may have a generally similar construction in which each of the sub-containers 910a-910c defines a cylindrical shape that holds a subset of the absorbing material 905 with a porous material. For example, and with reference to the first sub-container 910a, the first sub-container 910a may include an inner shell 912a, an outer shell 918a, and end pieces 922a, 923a. Broadly, the inner shell 912a, the outer shell 918a, and the ends pieces 922a, 923a may collectively define cylindrical-type structure that fits about and generally encompasses a portion of the pump shaft 820. For example, the inner shell 912a may include one or more material sections that define an interior surface 913a of the porous container 910a. Ends of the cylindrical-type shape defined by the porous container may be established by the end pieces 922a, 923a. The inner shell 912a, the outer shell 918a, and the end pieces 922a, 923a may cooperate to define a holding space 925a of the porous container 910a. The holding space 925a may be configured to house the absorbing material 905 therein, including being configured to house a sufficient amount of absorbing material 905 in order for the absorbing material 905 to collectively be capable of trapping fission products for a period of years, such as a period of one year, a period of three years, a period of five years, or longer. Optional internal supports 924a may be arranged within the holding space 925a in order to connect the inner shell 912a, the outer shell 918a, and the end pieces 922a, 923a to one another. In some cases, fasteners of various types may also be used to couple the inner shell 912a, the outer shell 918a, and the end pieces 922a, 923a to one another. As further shown, with reference to FIG. 9B, the first sub container 910c may further include a recessed band 327a that is configured to receive a portion of the coupler 824.

With continued reference to the first sub-container 910a, the inner shell 912a may define a plurality of holes 914a through a thickness of the material that defines the inner shell 912a. Each hole of the plurality of holes 914a may have a hole diameter 915a. The holes diameter 915a may be sized in order to permit passage of (and adequate flow of) fission products through the inner shell 912a for absorption by the absorbing material 905. The hole diameter 915 may further be sized in order to contain the absorbing material in the porous container 910a such that absorbing material 905 is not readily released therefrom. The outer shell 918a may define an outer surface having a plurality of holes 920a have similar properties and dimensions as the plurality of holes 914a of the inner shell 912a. While the plurality of holes 914a, 920a are shown in FIGS. 9 and 10 as having a generally consistent size and shape, this is not required. It will be appreciated that the holes of the plurality of holes 914a, 920a may be of any sufficient size and shape, including non-uniform and non-symmetrical shapes, any of which may or may not uniformly distributed along the material of the respective shells.

The second sub-container 910b may be substantially analogous to the first sub-container 910a and include: an inner shell 912b, an outer shell 918b, end pieces 922b, 923b, holding space 925b, optional internal supports 924b, a plurality of holes 914b, a hole diameter 915b, and a plurality of holes 920b; redundant explanation of which is omitted here for clarity. Further, the third sub-container 910c may be substantially analogous to the first sub-container 910a and include: an inner shell 912c, an outer shell 918c, end pieces 922c, 923c, holding space 925c, optional internal supports 924c, a plurality of holes 914c, a hole diameter 915c, and a plurality of holes 920c; redundant explanation of which is omitted here for clarity.

Notwithstanding the foregoing similarities, the third sub-container 910c may be configured such that one end of the third sub-container is adapted to fit over the mechanical seal 812. For example, and as shown in FIG. 10, the end piece 923c of the third sub-container 910c may be configured with an annular seat 927c that is configured to receive the mechanical seal 812. By receiving at least some of the mechanical seal 812 within the third sub-container 910c, the absorbing material 905 may be arranged about an entire periphery of the mechanical seal 812. Arranging the absorbing material 905 about an entire periphery of the mechanical seal 812 may increase the amount of fission products captured by the trap 900 at the mechanical seal 812, which represents a potential source of emissions of the fission products.

As described herein, the porous container 910 may be enclosed in a volume 992 that is defined by the assembly 990, such as optionally a sealed volumed. The assembly 990 may include any appropriate combination of components and sub-assemblies appropriate to form and maintain the volume 992 about the porous container 910. In the example of FIGS. 9 and 10, the assembly 990 is shown as including a sleeve 930 and flanges 937a, 937b. The sleeve 930 may be a pipe segment other cylindrical structure that operates to form a jacket about the porous container 910. For example, and as shown in FIGS. 9 and 10, the sleeve 930 may define an outer surface 931a, an inner surface 931b, and an inner volume 932 running along the inner surface 931b. The sleeve 930 may be further defined by first and second sleeve ends 935a, 935b that define terminal opposing ends of the sleeve 930. The sleeve 930 is further shown as including first and second ports 934a, 934b. The first and second ports 934a, 934b may be couplable with certain valving and tubing, as described in greater detail below, in order to permit purging of the volume 992 with an inert gas. The sleeve 930 may be coupled with the flange 937a at the first sleeve end 935a. Further, the sleeve 930 may be coupled with the flange 937b at the second sleeve end 935b.

The assembly 990 may be coupled such that the sleeve 930 is coupled to each of the impeller housing flange 806 and the motor flange 892. For example, the flange 937a may be arranged adjacent the impeller housing flange 806 with a gasket 810 disposed therebetween. Fasteners 807 and corresponding nuts 808 may be associated with the flanges 937a and the flange 806 and used to encourage the flange 937a and flange 806 toward one another to compress the gasket 810 therebetween, thereby establishing a gasket-sealed connection between the sleeve 830 and the impeller housing 802. Further, the flange 937b may be arranged adjacent the motor flange 892 with a gasket 896 disposed therebetween. Fasteners 898 and corresponding nuts 899 may be associated with the flanges 937b and the flange 892 and used to encourage the flange 937b and flange 892 toward one another to compress the gasket 896 therebetween, thereby establishing a gasket-sealed connection between the sleeve 830 and the pump motor 890.

The trap 900 is further shown in FIGS. 9 and 10 as including a pair of bearings, such as a first bearing 940a and a second bearing 940b. Each bearing of the pair of bearings may generally be any type of bearing that permits free rotational movement of the pump shaft 820, while constraining radial deviation of the pump shaft 820 from the axis of rotation. In the example of FIGS. 9 and 10, the first and second bearings 940a, 940b may be plated-mounted bearings that stabilize the pump shaft 820 relative to the sleeve 930. For example, the first bearing 940a may include an inner race 942a that is fit onto the pump shaft 820, such as being press fit on to the pump shaft 820, and allowed to rotate with the pump shaft 820. The first bearing 940a may further include an outer race 946a that is fixed to a plate 948a. The first bearing 940a may further include a rotational component 944a (e.g., balls or spinners of an example ball bearing) that is arranged annually between the inner race 942a and the outer race 946a in order to permit the rotation of the inner race 942a relative to the outer race 946a. The second bearing 940b may be substantially analogous to the first bearing 940a and may include an inner race 942b, a rotational component 944b, an outer race 946b, and a plate 948b; redundant explanation of which is omitted here for clarity.

With reference to FIGS. 9 and 10, the trap 900 is further shown as including or otherwise being associated with a gas management system 970. The gas management system 970 may operate generally to purge the volume 992 of oxygen and to replace the oxygen with an inert gas. In the example of FIGS. 9 and 10, the gas management system 970 is shown as including tubing 972a, 972b with corresponding valves 974a, 974b. In one example, the tubing 972a and corresponding valve 974a may be coupled with the volume 992 via the first port 934a. The tubing 972a may be coupled with a vacuum system or the like that is configured to draw a vacuum flow 976 from the volume 992 in order to remove oxygen from the volume 992. Further, the tubing 972b and corresponding valve 974b may be coupled with the volume 992 via the second port 944b. The tubing 972b may be coupled with an inert gas source or the like that is configured to provide an inert gas flow 978 to the volume 992.

The trap 900 may be coupled such that porous container 910 is mounted about the pump shaft 820. For example, each sub container of the porous container 910 may be arranged to encircle a portion of the pump shaft 820 within the sealed volume 892. In relation to the third sub container 910c, the third sub-container 910c may be advanced along the pump shaft 820 such that the annular seat 923a is fit over a periphery of the mechanical seal 820. In some cases, the third sub-container 910c may be fixed to the sleeve 830 or otherwise fixed within the sealed volume 892 such that the sub-container is prevented from rotation with the pump shaft 820. As shown in FIG. 10, the third sub-container 910c may remain annularly spaced with the pump shaft 820 within the sealed volume 892. Next, the first bearing 940a may be advanced along the pump shaft 820 with the pump shaft 820 press fit into the inner race 942a. The plate 948a may be contoured to fit within the inner volume 932 defined by the sleeve 930 and configured to engage the inner surface 931a in a manner that mitigates axial movement of the first bearing 940a. Fasteners, including set screws and the like may also be used to constrain axial movement of the first bearing 940a. The plate 948a may also be used to support the third sub-container 910c within the sealed volume 892.

In relation to the second sub-container 910b, the second sub-container 910b may be advanced along the pump shaft 820 and fixed to the sleeve 830 or otherwise be fixed within the sealed volume 892 such that the sub-container is prevented from rotation with the pump shaft 820, including be fixed or supported by the plate 948a of the first bearing 940a. As shown in FIG. 10, the second sub-container 910c may remain annularly spaced with the pump shaft 820 within the sealed volume 892. Next, the second bearing 940b may be advanced along the pump shaft 820 with the pump shaft 820 press fit into the inner race 942b. The plate 948b may be contoured to fit within the inner volume 932 defined by the sleeve 930 and configured to engage the inner surface 931a in a manner that mitigates axial movement of the second bearing 940b. Fasteners, including set screws and the like may also be used to constrain axial movement of the second bearing 940b. The plate 948b may also be used to support the second sub-container 910b within the sealed volume 892.

In relation to the first sub-container 910a, the first sub-container 910a may be advanced along the pump shaft 820 and fixed to the sleeve 830 or otherwise be fixed within the sealed volume 892 such that the sub-container is prevented from rotation with the pump shaft 820, including be fixed or supported by the plate 948b of the second bearing 940b. As shown in FIG. 10, the second sub-container 910c may remain annularly spaced with the pump shaft 820 within the sealed volume 892.

In operation, and as shown in relation to FIGS. 11 and 11A, radioactive iodine 1102 (and/or other fission product, including, without limitation tritium, tellurium, cesium, or bromine) may be emitted from along the pump shaft 820. The porous container 910 including the absorbent material 905 may be position adjacent the pump shaft 820. In this regard, the radioactive iodine 1102 may travel from along the pump shaft 820 and toward the porous container 910 (e.g., the third sub container 910c). The radioactive iodine may enter the third sub-container 910c via the plurality of inner holes 914c. As shown in FIG. 11A, the radioactive iodine 1102 may define a gradient 1104 such that the radioactive iodine 1102 is dispersed within and collected by the absorbing material 905. By collecting the radioactive iodine in the absorbing material 905, the fission product trap 900 may operate to reduce the release of fission products into the broader containment vessel or region of the reactor system.

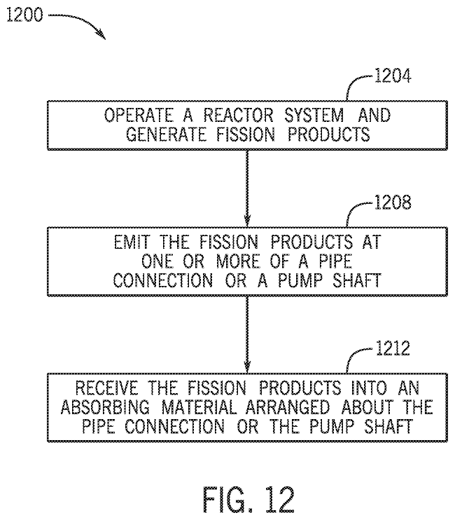

FIG. 12 depicts a flow diagram of an example method for capturing fission products from a reactor system. At operation 1204, the reactor system is operated in order to generate fission products. For example, and with reference to FIG. 1, the system 100 may broadly be operable to generate fission products, including generating certain materials and byproducts that exhibit radioactive properties. As one example, the system 100 generates or causes a build up of certain radioactive iodine.

At operation 1208, fission products are emitted at one or both of a pipe connection or pump shaft of the reactor system. For example, and with reference to FIGS. 6 and 11, fission products may be emitted from the pipe connection 250 and/or from along the pump shaft 820. For example, radioactive iodine 602 may be emitted from the pipe connection 250. Further, radioactive iodine 1102 maybe emitted from along the pump shaft 820.

At operation 1212, fission products are received into an absorbing material arranged about the pipe connection or the pump shaft of the reactor system. The absorbing material is arranged in a porous container mounted about the pipe connection or the pump shaft. For example, and with continued reference to FIGS. 6 and 11, the radioactive iodine 602 from the pipe connection 250 may be received by, and trapped within, the absorbing material 305 of the fission product trap 300. Further, the radioactive iodine 1102 from the along the pump shaft 820 may be received by, and trapped within, the absorbing material 905 of the fission product trap 900.

Other examples and implementations are within the scope and spirit of the disclosure and appended claims. For example, features implementing functions may also be physically located at various positions, including being distributed such that portions of functions are implemented at different physical locations. The foregoing description, for purposes of explanation, uses specific nomenclature to provide a thorough understanding of the described examples. However, it will be apparent to one skilled in the art that the specific details are not required in order to practice the described examples. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A fission product trap for a pipe connection of a reactor system, the trap comprising
a porous container mounted about the pipe connection and having an absorbing material contained therein that is configured to collect fission products emitted from the pipe connection; and
an assembly encompassing the porous container and defining a volume about the porous container and the pipe connection.

2. The trap of claim 1, wherein the absorbing material comprises loose activated carbon, silver zeolite, or carbon nanostructures.

3. The trap of claim 1, wherein the fission products comprise radioactive iodine, tritium, tellurium, cesium, or bromine.

4. The trap of claim 1, wherein the porous container encompasses the pipe connection and forms a sealed volume therearound.

5. The trap of claim 1, wherein
the pipe connection is defined by a pair of flanges, and
the porous container defines a recessed band configured to receive the pair of flanges therein.

6. The trap of claim 5, wherein
the porous container comprises an inner shell that define the recessed band, and an outer shell arranged about the inner shell and defining a holding space therebetween, and
the absorbing material is arranged in the holding space.

7. The trap of claim 6, wherein the inner shell defines a plurality of holes positioned within the recessed band.

8. The trap of claim 1, wherein the assembly comprises
a sleeve arranged over the porous container and the pipe connection, and
a pair of clamping assemblies, each clamping assembly of the pair of clamping assemblies arranged along an end of the sleeve and configured to define a sealed connection with a respective pipe associated with the pipe connection.

9. The trap of claim 8, wherein each clamping assembly of the pair of clamping assemblies comprises
a clamping shaft having a threaded outer surface and an axial passage therethrough, the axial passage configured to receive the respective pipe,
a gripping element abutting the clamping shaft along an outer surface of the respective pipe, and
a clamping nut having a complementary threaded inner surface configured to threadably engage the threaded outer surface of the clamping shaft.

10. The trap of claim 9, wherein, in response to a threaded engagement of the clamping shaft and the clamping nut toward one another, the gripping element is compressed therebetween and encouraged toward the outer surface of the respective pipe to establish a sealed boundary of the clamping assembly.

11. A system comprising
the trap of claim 1,
a first pipe, and
a second pipe, wherein the first and second pipe cooperate to define the pipe connection.

12. A fission product trap for a pump shaft of a pump of a reactor system, the trap comprising
a porous container mounted about the pump shaft and having an absorbing material contained therein that is configured to collect fission products emitted from along the pump shaft; and
an assembly encompassing the porous container and defining a volume about the porous container and the pump shaft.

13. The trap of claim 12, wherein absorbing material comprises loose activated carbon, silver zeolite, or carbon nanostructures.

14. The trap of claim 12, wherein the fission products comprise radioactive iodine, tritium, tellurium, cesium, or bromine.

15. The trap of claim 12, further comprising at least one bearing mounted in a plate and receiving the pump shaft therethrough, wherein the at least one bearing is configured to permit rotation of the pump shaft while constraining radial movement of the pump shaft relative to the gas tight assembly.

16. The trap of claim 15, wherein the porous container comprises three sub containers, each sub container separated from one another by a respective one of the at least one bearing.

17. The trap of claim 16, wherein
the pump shaft is associated with a mechanical seal, and
a first sub container of the porous container is configured to fit about a periphery of the mechanical seal and extend along and separated from the pump shaft.

18. The trap of claim 12, wherein the assembly is configured to form a sealed volume about the pump shaft and comprises
a sleeve arranged over the porous container and the pump shaft, and
a pair of opposing flanges, wherein the sleeve is gasket-sealed to each flange of the pair of opposing flanges at respective ends of the sleeve.

19. A system comprising
the trap of claim 12, and
the pump shaft.

20. A method for capturing fission products from a reactor system, the method comprising
operating the reactor system including generating the fission products;
emitting the fission products at one or both of a pipe connection or pump shaft of the reactor system, and
receiving the fission products into an absorbing material arranged about the pipe connection or the pump shaft of the reactor system, wherein the absorbing material is arranged in a porous container mounted about the pipe connection or the pump shaft.
